(19) United States
(12) Patent Application Publication
(10) Pub. No.: US 2015/0023904 A1
(43) Pub. Date: Jan. 22, 2015

(54) NEW APPLICATION OF PVP-I

(71) Applicant: Bo Song, Shenzhen (CN)

(72) Inventor: Bo Song, Shenzhen (CN)

(21) Appl. No.: 14/377,830

(22) PCT Filed: Jun. 19, 2013
(86) PCT No.: PCT/CN2013/077499

§ 371 Date: Aug. 8, 2014

(30) Foreign Application Priority Data
May 17, 2013 (CN) 2013101833944

(51) Int. Cl. A01N 43/36

(52) U.S. Cl. CPC A01N 43/36
USPC 424/78.07

(57) ABSTRACT

The present invention relates to an application of povidone iodine (PVP-I) in the preparation of a medicine treating premature ejaculation, wherein the medicine is the compound consisting of PVP-I and any other biologically compatible carrier, such as PVP-I disinfectant or Andoful PVP-I disinfectant. The beneficial effect is: by experiment, PVP-I is proved to be able to increase patients' ILET and have a significant therapeutic effect for those suffering premature ejaculation.

### TECHNICAL FIELD

The present invention relates to medical technology, and especially, to a new application of PVP-I.

### DESCRIPTION OF RELATED ART

As the most common sexual dysfunction arising in young men, premature ejaculation takes up an incidence of 21%-33% among male adults. Currently, the main therapies include surgical treatment and oral drug taking, wherein, for premature ejaculation, it is recommended to take SSRIs, represented by sertraline and paroxetine, whose mechanism of action is that, to increase the synaptic space 5-HT concentration by inhibiting the reuptake position of presynaptic membrane, so as to delay ejaculation. From clinical studies, such drugs have certain effects in curing premature ejaculation, but with extremely obvious side effects of different levels, including lethargy, dysphoria, bruxism and nausea, which disappear 2 to 3 days later after drug withdrawal. For patients suffering renal failure, there is still no report about whether these drugs can be used. Therefore, the market at present cannot provide external preparations having conspicuous effects upon premature ejaculation.

### BRIEF SUMMARY OF THE INVENTION

The present invention mainly aims at providing a new application of PVP-I in relation to the disadvantages of the prior art above.

To solve the existing technical problems, the present invention adopts the following technical solution: the application of PVP-I in the preparation of a medicine treating premature ejaculation.

The medicine is the compound consisting of PVP-I and any other biologically compatible carrier.

The medicine is PVP-I disinfectant.

The medicine is an external preparation, which is directly smeared at the locations 1.5 to 2 cm above and below the coronal sulcus.

The beneficial effect of the present invention is: by experiment, PVP-I is proved to be able to increase patients' ILET and have a significant therapeutic effect for those suffering premature ejaculation.

### BRIEF DESCRIPTION OF THE SEVERAL VIEWS OF THE DRAWINGS

FIG. 1 is the scatter plot of ILET in 31 patients before and after treatment;

FIG. 2 is the scatter plot of ILET in patients of Group a (sertraline only) before and after treatment;

FIG. 3 is the scatter plot of ILET in patients of Group b (Andoful PVP-I disinfectant only) before and after treatment;

FIG. 4 is the scatter plot of ILET in patients of Group c (drug combination) before and after treatment;

The execution, functional features, and advantages of the present invention will be further detailed in combination with the embodiments and the drawings.

### DETAILED DESCRIPTION OF THE INVENTION

To understand the essence of the present invention more clearly and visually, the technical solution of the present invention will be detailed by embodiments in combination with the drawings.

### Experimental Case

### 1. Experimental Subject

31 patients (27±5 years old) suffering premature ejaculation for 0.5 to 2 years who have abandoned other therapies for at least 1 month before participating in this experiment. With normal sexual desire, and without drug abuse experience, suspected drug use, or contact with radioactive materials, all these patients are composed of 10 with circumcision, 1 with renal insufficiency, 2 with unsatisfactory sexual life after marriage, and 1 with weak erection.

### 2. Experimental Standard

Taking intravaginal ejaculatin latency time (IELT) as the experimental parameter, if the time after insertion into the vagina is less than 1 minute, deem it as 1 minute. Take IELT for 3 times before and after the treatment, then calculate the mean value.

### 3. Experimental Method

The experiment was performed by observation of three groups: a, b and c, wherein,

for Group a, sertraline, commonly recommended for premature ejaculation, is adopted, which was of 50 mg and taken QN for 16 to 21 days; for Group b, Andoful PVP-I disinfectant (mainly consisting of PVP-I), produced by Shenzhen Andoful Disinfection Hi-Tech Shareholding Co., Ltd., was used for smearing at the locations 1.5 to 2 cm above and below the coronary sulcus, taken QN for 7 to 8 days; for Group c, sertraline and Andoful PVP-I disinfectant were both taken, including sertraline of 25 mg taken QN and Andoful PVP-I disinfectant taken for 7 to 8 days by the usage mentioned above. IELT shall be calculated after 1 month of drug taking respectively.

### 4. Experimental Results

4.1 SPSS 18.0 was adopted to calculate IELT of each group. See Table 1 for specific results:

Table 1 is the list of IELT before and after treatment, wherein, 1 and 2 represent IELT before and after treatment respectively, for example, A1 denotes IELT before treatment, A2 indicates IELT after treatment and N refers to the number of patients.

| | | Mean | Standard |
|---|---|---|---|
| | N | value | deviation |
| A1 | 4 | 1.25 | 0.50 |
| A2 | 4 | 3.75 | 0.96 |
| B1 | 13 | 1.38 | 0.65 |
| B2 | 13 | 6.54 | 2.67 |
| C1 | 14 | 1.79 | 0.58 |
| C2 | 14 | 6.36 | 2.10 |

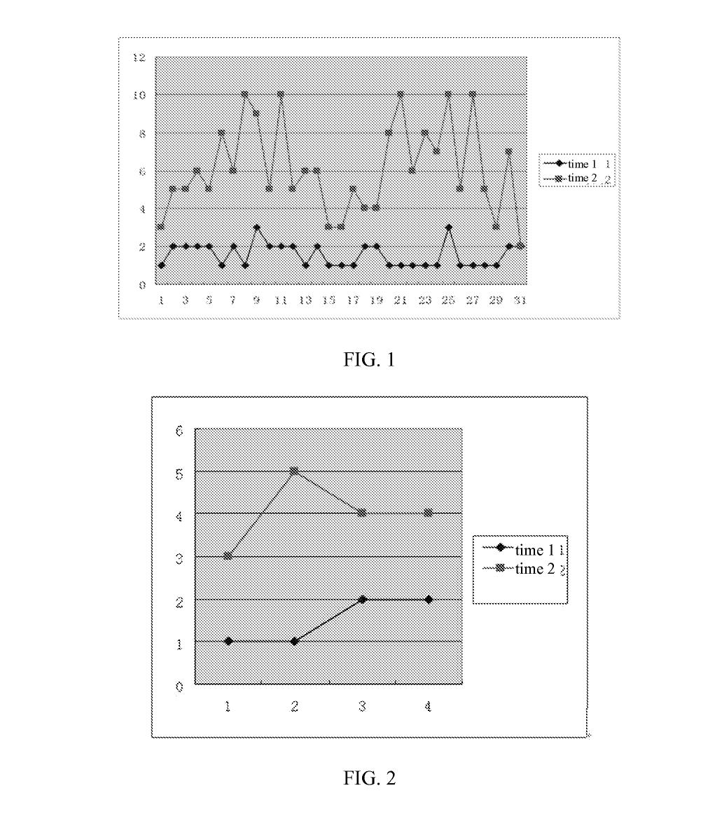

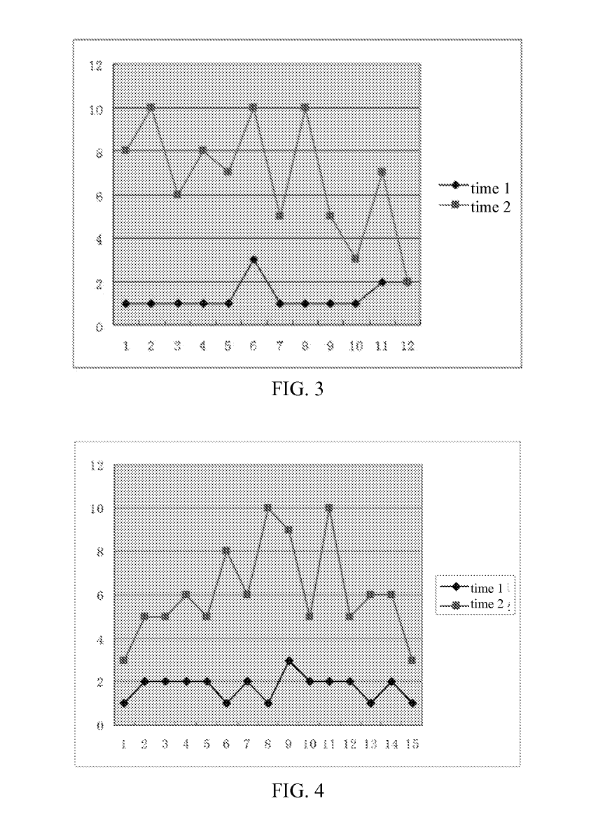

4.2 As shown in FIG. 1 to FIG. 4, the scatter plots are constructed based on the treatment time. From FIG. 1, it can be seen that, compared with that before treatment, IELT after treatment moves upwards with only one data point overlapping, namely, among the 31 patients, 30 have prolonged IELT, except for one (who belongs to Group b (taking Andoful PVP-I disinfectant only)). While from FIG. 2, the IELT of 4 patients of Group a adopting sertraline has been prolonged. From FIG. 3, 12 of the 13 patients of Group b taking Andoful PVP-I disinfectant have their IELT prolonged. While from FIG. 4, all the 14 patients of Group c taking both sertraline and Andoful PVP-I disinfectant have prolonged IELT.

4.3 Statistical Analysis

All the data were analyzed statistically with statistical software SPSS 18.0, and for single variables, t was inspected by taking the inspection standard α=0.05, with the inspection results as below: codes a, b and c represent different groups, the data following denote treatment time, 1 signifies IELT before treatment, 2 represents IELT after treatment and N as the number of patients.

Table 2 shows the inspection results of IELT t before and after treatment to each group:

| | N | t | df | Sig. |
|---|---|---|---|---|
| Group a1 & a2 | 4 | −5.000 | 3 | .015 |
| Group b1 & b2 | 13 | −6.797 | 12 | .000 |
| Group c1 & c2 | 14 | 8.000 | 13 | .000 |

Table 3 IELT Inspection Results Before and After Treatment to Group a and Group b

| | t | df | Sig. |
|---|---|---|---|
| Before treatment | .378 | 15 | .711 |
| After treatment | 2.014 | 15 | .062 |

Table 4 IELT t Inspection Results Before and After Treatment to Group a and Group c

| | t | df | Sig. |
|---|---|---|---|
| Before treatment | 1.672 | 16 | .114 |
| After treatment | 2.375 | 16 | .030 |

Table 5 IELT t Inspection Results Before and After Treatment to Group b and Group c

| | t | df | Sig. |
|---|---|---|---|
| Before treatment | 1.695 | 25 | .102 |
| After treatment | −.197 | 25 | .845 |

### 5. Conclusion

As a disinfectant commonly used clinically, PVP-I is widely applied in the disinfection of skin and mucosa and has been found to be effective in treating premature ejaculation through this research.

From scatter plots 1 to 4, comparing with that before treatment, IELT of the patients after treatment is enhanced, and among the 31 patients, only one person's IELT keeps unchanged, which indicates unobvious therapeutic effect.

In terms of intra-group statistical results (Table 2), before and after treatment, IELT of Group a, b and c at 0.05 differs statistically, showing obviously prolonged IELT comparing with that before treatment.

In the contrast (Table 3-5) of the treatment groups, at 0.05, no statistical discrepancy exists among the groups before treatment, indicating that intra-group statistical discrepancy does not arise. While after treatment, statistical discrepancy emerges between Group a and Group c, showing that the group taking both of the drugs may have better effect than the group adopting sertraline only; no statistical discrepancy exists between Group b and Group c, indicating there does not exist discrepancy between the group taking both drugs and the group taking PVP-I only. Thus, it is predicted that, drug combination has an advantage over taking sertraline only, and achieves an effect close to that by taking PVP-I only.

As the most common sexual dysfunction arising in men, premature ejaculation takes up an incidence of 21%-33% among male adults. Currently, to cure the disease, it is recommended to use SSRIs, represented by sertraline and paroxetine. This research selects sertraline for a discussion in terms of its therapeutic effect and price. The corresponding mechanism of action is that, inhibiting the reuptake position of presynaptic membrane 5-HT to increase the synaptic space 5-HT concentration, so as to delay ejaculation. From clinical studies, such drugs have certain effects in curing premature ejaculation, but with extremely obvious side effects. In this research, 5 patients exhibited side effects of different levels, including lethargy, dysphoria, bruxism and nausea, which disappeared 2 to 3 days later after drug withdrawal. For patients suffering renal failure, there is still no report about whether these drugs can be used.

For this, PVP-I is properly prevented from the disadvantages of such drugs, and with respect to the drug use at present, no patient has been found to have side effect or adverse reaction.

In view of the experimental data of this research, drug combination has an advantage over taking sertraline only, and achieves an effect close to that by taking PVP-I only, indicating that PVP-I can effectively reduce sertraline dosage, and applying PVP-I separately can increase ILET of patients with effect, which has significant therapeutic effect for those suffering premature ejaculation.

The description above is only to illustrate the preferred embodiments but not to limit the patent scope of the present invention. Any equivalent structure or procedure substitution based on the Specification and the Drawings of the present invention, or direct or indirect application in other related technical fields shall be all covered by the protection scope of the present invention.

1. An external preparation for improving premature ejaculation comprising PVP-I.

2. The external preparation for improving premature ejaculation according to claim 1, wherein further comprising at least one of biologically compatible carriers.

3. The external preparation for improving premature ejaculation according to claim 1, wherein the PVP-I is a PVP-I disinfectant.

4. A method of using the external preparation to treating premature ejaculation according to claim 1 comprising step of using the external preparation for improving premature ejaculation of claim 1 directly smear it on an area between 1.5 cm above and 2 cm below the coronal sulcus.
